(19) United States
(12) Patent Application Publication
(10) Pub. No.: US 2006/0265863 A1
(43) Pub. Date: Nov. 30, 2006

(54) Manufacturing method of slider and device for manufacturing slider

(75) Inventor: Ryuta Murakoshi, Hong Kong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/442,604

(22) Filed: May 30, 2006

(30) Foreign Application Priority Data
May 27, 2005 (JP) JP2005-155899

(51) Int. Cl. G11B 5/127

(52) U.S. Cl. 29/603.16; 29/417; 219/121.6; 29/737

(57) ABSTRACT

A manufacturing method of slider, comprising the steps of: cutting step; at which cutting a row bar constituted by an array of slider-forming elements into individual sliders; and radiating step; at which radiating electromagnetic wave and making it reflected and transmitted to a cutting surface of the individual slider in a direction different from a direction of radiating the electromagnetic wave, so as to reduce a height extending from an air bearing surface of the individual slider of burrs, which are generated around the cutting surface of individual slider.

### FIELD OF THE INVENTION

The invention relates to a method for manufacturing slider used in a hard disk drive, and more particularly to a method for removing burrs generated on a cutting surface of the slider which is formed by cutting a row bar.

### BACKGROUND OF THE INVENTION

As a recording media of high speed, sufficient capacity, strong reliability and low cost, disk drives are widely used for digital information recording. The disk drive has a slider that incorporates at least one of a recording element for writing information to the recording media and a reading element for reading information therefrom. A read/write portion having the writing element or reading element is disposed at one end of the slider. A surface of the slider that faces the recording medium surface is referred to as an air bearing surface (ABS).

Airflow is generated between the slider and the recording medium, which rotates at a high speed, when the slider runs information reading/writing operation to the recording medium. The slider is floated slightly above the recording medium via the airflow. Meanwhile the distance between the ABS and a surface of the recording medium is called flying height. The bit length of the recording medium will be shortened if the flying height reduces; therefore, decreasing of the flying height benefits density improvement of the recording medium. For this purpose, it is required that the flying height be reduced more critically according to demand of higher density of disk drive.

A method for manufacturing this type of slider is described in conjunction with FIGS. 15A˜15F. Firstly, as shown in FIG. 15A, a plurality of elements 13 used as sliders are formed on a wafer 11. Then, the wafer 11 with the plurality of the elements 13 formed thereon is sliced into pluralities of bar-shaped row bars 12 using a grinding tool 26. The row bar 12 is cut away along cutting surfaces T1, T2. This state is shown in FIG. 15B. Next, as shown in FIG. 15C, the separated row bar 12 is ground by a special grinding device along its cutting surface T2 and an ABS which faces the recording medium is formed. The figure shows a perspective view of the row bar 12 when rotated in a direction shown in FIG. 15B. After that, as shown in FIG. 15D, the row bar 12 is diced into individual sliders 1 along cutting lines 14 by a grinding tool 27.

However, during process of cutting the wafer into row bars or cutting the row bar into sliders using the grinding tools, since machining stress is formed in cutting process, compressive stress is generated in the cutting surface of the slider; thus burrs are generated on the cutting surface. When cutting the wafer into row bars, as shown in FIGS. 15B, 15C, burrs C11, C12 are formed on both ends of the cutting surfaces T1, T2 (burrs formed on one ends of the T1, T2 are not shown). As shown in FIG. 15D which schematically illustrates an enlarged view of the slider, during process of cutting a row bar into sliders, burrs C2 are formed on edges A1, A2 along a cutting surface S2 (burrs formed on the edge A2 are not shown in the figure). Similarly burrs C3 are formed on edges B1, B2 along the cutting surface S2 (burrs formed on the edge B1 are not shown in the figure). Furthermore, the same burrs C2, C3 are also formed on a cutting surface S3.

FIGS. 15E-15F illustrate sectional views of FIG. 15D along X-X line and Y-Y line respectively. The burrs C2 are extruded from the ABS, and the burrs C2 are also formed on the opposite surface S5 of the ABS. The burrs C3 are extruded from surfaces S3, S4 perpendicular to the ABS.

In ABS forming process, 50-80 μm thick of material is ground off from the cutting surface T2; therefore, among these burrs, the burrs C12 on one side of the cutting surface T2 are eliminated. The functions of the ABS will not be influenced even if some burrs C11 are still remained on one side of the cutting surface T1. The burrs C3 are extruded from the surfaces S3, S4; moreover, since the surfaces S3, S4 are not needed to be very flat, the function thereof will not be affected even if residual burrs are still remained thereon. However, as the burrs C2 are extruded from the ABS, they have great influence on decreasing of the flying height, as well as density improvement of the recording medium. Also, the burrs C2 formed on surface opposite to the ABS may also hinder connection with a flexure.

Accordingly, technology for preventing these residual burrs is disclosed (refer to patent reference 1), in which besides grinding cutting surfaces, the slider is provided with pre-grooves thereon along which the slider is cut off, thus preventing the burrs protruding from the ABS.

Patent reference 1: Japanese Patent Application Publication NO. 2001-143233.

Patent reference 2: Japanese Patent Application Publication NO. 1994-84312.

Patent reference 3: Japanese Patent Application Publication NO. 1999-328643.

However, some problems cannot be solved by the technology art provided in patent reference 1. First of all, the burrs themselves are not eliminated but remained in the pre-grooves; therefore universal application of ABS shape design is narrowed. That is, rails that control flying height of the slider when in operation are formed on the ABS, but if residual burrs are remained thereon, the height of the rails will be difficult to be reduced.

Secondly, forming pre-grooves at sidewalls of the slider causes substantial increase in width of the cutting portion. In recent years, with miniaturization of disk drive devices for purpose of being incorporated in mobile phones, sliders become 30% (slider of 1.0 mm×1.235 mm×0.3 mm) to 20% (slider of 0.7 mm×0.85 mm×0.23 mm) size of traditional sliders, and even smaller sliders are being researched. The higher the extent to which the sliders are miniaturized is, the bigger the area occupied by the cutting portions in the wafer is. Therefore, width increment of the cutting portion leads to number reduction of the sliders manufactured from a wafer, thus resulting in decreasing of production efficiency, as well as cost increase of a slider. For reducing cutting width, more precise manufacture is needed; however, reduction of the cutting width will be limited if the pre-grooves are formed thereon.

Furthermore, though the burrs can be removed by grinding the cutting surfaces; however, grinding separated sliders one by one makes the production efficiency slowed down.

For this purpose, a technology for completely removing the burrs is expected, and as a kind of it, a technology which uses laser and is disclosed in patent reference 2, 3 is noted by inventors of the invention. However, following problems arises in the technology in which laser is utilized to remove burrs. Namely, if laser is irradiated on the ABS, performance of the ABS will be degraded adversely; therefore, it is necessary to irradiate laser to the cutting surface. In irradiation process, the abovementioned problem of lowered production efficiency will exist, if the laser is irradiated to the cutting surfaces after the sliders are separated one by one; therefore, irradiation should be implemented when the sliders are held on a cutting tool. However, since the pitch between the sliders is extremely narrow, accordingly, the laser can be transmitted to the cutting surface only at a very small angle; hence energy cannot be transferred to the cutting surface. Moreover, since irradiation is performed in a small angle, the incidence angle should have high precision.

Accordingly, when obliquely irradiating laser to the slider, the slider should be placed on a horizontal plane, and laser should be obliquely irradiated to the slider from a position over the slider; however, it is difficult to obliquely irradiate laser to the slider due to structure feature of the laser transmission device. For this sake a method is proposed, in which the slider is mounted on a sloping plane and laser is irradiated from a top position, thus realizing oblique irradiation; however, due to some reasons such as limitation of depth of focus and movement range in vertical direction of the irradiation device, amount of the sliders which can receive irradiation synchronously is limited.

### SUMMARY OF THE INVENTION

A main object of the invention is to provide a manufacturing method of slider, in which burrs generated on the sliders during process of cutting a row bar into sliders, can be removed via simple means under condition that the sliders are held on a cutting fixture.

A manufacturing method of slider, comprising the steps of: 1) cutting step; at which cutting a row bar constituted by an array of slider-forming elements into individual sliders; and 2) radiating step; at which radiating electromagnetic wave and making it reflected and transmitted to a cutting surface of the individual slider in a direction different from a direction of radiating the electromagnetic wave, so as to reduce a height extending from an air bearing surface of the individual slider of burrs, which are generated around the cutting surface of individual slider.

After transmitted, the electromagnetic wave does not radiate directly on the cutting surface, but is reflected at an end such that its transmitted direction is changed and then radiates on the cutting surface; accordingly, the electromagnetic wave is transmitted to the cutting surface at a more suitable angle by adjusting its reflection angle.

In the cutting step, when holding the separated sliders, it is preferable to hold them face to face and with a cutting space forming in cutting process maintained between the adjacent cutting surfaces. Moreover, preferably, a part of the sliders are moved to deviate from a longitudinal axis of the row bar so as to make the nonadjacent sliders being adjacent to each other and are held face to face with a space formed between the cutting surfaces thereof.

In the radiating step, preferably, a part of the irradiated electromagnetic wave is reflected at a direction different from a direction of the rest electromagnetic wave, and the part of the electromagnetic wave has at least a part to radiate to a side of the facing cutting surfaces of the adjacent sliders, and the rest electromagnetic wave has at least a part to radiate to the other side of the facing cutting surfaces of the adjacent sliders.

More particularly, the method comprises an individual radiating step of irradiating the electromagnetic wave to one of the spaces, and then making the irradiated electromagnetic wave reflected to the cutting surfaces at two sides adjacent the space after the electromagnetic wave passes through the space or during passing process. The radiating step may also comprise an individual radiating step of irradiating a space between a first slider and a second slider which adjacent to each other; and another individual radiating step of altering irradiation direction of the electromagnetic wave and irradiating a space between the second slider and a third slider which adjacent to each other.

In addition, the radiating step may also comprise an entire radiating step of irradiating the electromagnetic wave to at least one slider and spaces at two sides of the slider, and making the irradiated electromagnetic wave reflected to the cutting surfaces at two sides adjacent the space after the electromagnetic wave passes though or during passing process. In the invention, the electromagnetic wave is irradiated under condition that the slider is shielded from irradiation of the electromagnetic wave.

In the cutting step, the row bar may be held on a cutting fixture in advance, and then cut into the individual sliders in a status of being held on the cutting fixture. In the radiating step, the electromagnetic wave is radiated directly to the cutting surfaces of the sliders when they are held on the cutting fixture.

In the radiating step, the electromagnetic wave is preferably irradiated with an incline angle of 15 degrees or larger relative to the cutting surface.

The electromagnetic wave may be a laser having a wavelength of 200˜3000 nm, and it is desired that the laser has an irradiation intensity of 0.2˜4.0 ml/mm².

A device for manufacturing slider of the invention includes a fixture, which holding a plurality of sliders adjacent to each other, wherein a cutting space is formed between the cutting surfaces of the two adjacent sliders formed by cutting the row bar, which has a size comparative to a cutting line for cutting the row bar; an electromagnetic wave irradiator; and a reflection device, which reflecting the electromagnetic wave irradiated by the irradiator and transmits the reflected electromagnetic wave onto the cutting surfaces of the sliders at a direction different from an irradiation direction of the irradiator.

Preferably, at least a part of the reflection device is provided in the cutting space or a rear space behind the cutting space when viewed from the irradiator; and the reflection device comprises at least two reflection angles relative to the irradiation direction of the irradiator, and a reflection surface to radiate the electromagnetic wave to the cutting surfaces at two sides of the cutting space or the rear space corresponding to the reflection angle.

Preferably, the reflection device is movable along a direction which has the irradiation direction of the irradiator as a vector element.

Preferably, the reflection surface has a convex configuration with its center extruding toward the irradiator or a concave configuration with its center recessed away from the irradiator. In addition, the irradiator may have an adjusting portion to adjust the irradiation direction of the irradiator.

Preferably, the slider manufacturing device comprises at least two reflection devices concomitantly provided in the different cutting spaces or rear spaces.

Specifically, preferably, the irradiator transmits an electromagnetic wave having a beam diameter that covers the different cutting spaces and the slider sandwiched between the cutting spaces. It is desired that the device have a shield portion to shield the slider sandwiched between the spaces from irradiation of the electromagnetic wave. It is desirable that the irradiator irradiates laser. Moreover, the fixture may also acts as a row bar cutting fixture.

As illustrated above, according to the manufacturing method of slider and device for manufacturing slider of the invention, burrs generated on the sliders during process of cutting a row bar into sliders, can be removed via simple means under condition that the sliders are held on a cutting fixture, thus eliminating limitation to further reducing flying height of the slider.

### BRIEF DESCRIPTION OF THE DRAWINGS

FIG. 1 shows a perspective view of a slider involved in slider manufacturing method of the invention;

FIG. 2 shows a flowchart of slider manufacturing method according to one embodiment of the invention;

FIG. 3 shows a step of the slider manufacturing method of the invention;

FIG. 4 shows a step of the slider manufacturing method of the invention;

FIG. 4A shows a partial perspective view of a divided row bar;

FIG. 5 shows a step of the slider manufacturing method of the invention;

FIG. 5A shows an enlarged view of portion A of FIG. 5;

FIG. 6 shows a schematic view illustrating irradiation range of the laser;

FIG. 7 shows a schematic view illustrating irradiation angle of the laser;

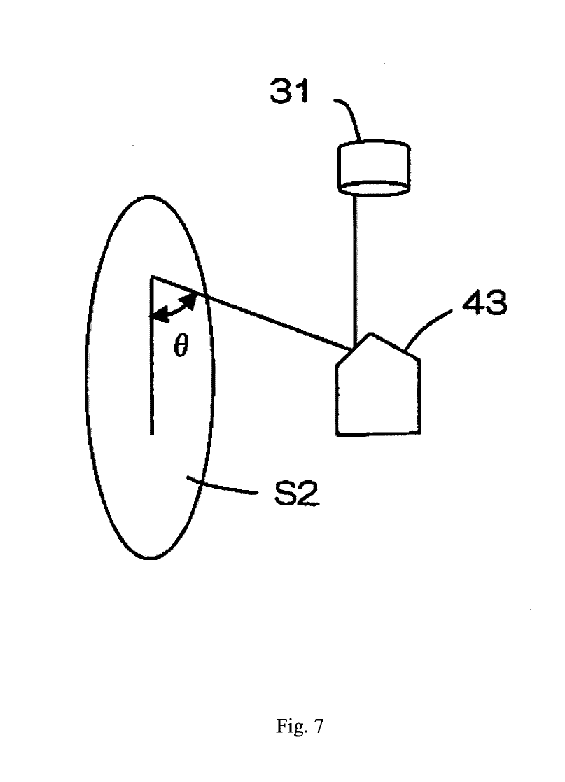

FIG. 8 shows schematic views illustrating effect of the slider manufacturing method of the invention;

FIG. 9 shows a view of a reflection device of a slider manufacturing device according to a modified embodiment of the invention;

FIG. 10 shows a view of a reflection device of a slider manufacturing device according to a modified embodiment of the invention;

FIG. 11 shows a view of a reflection device of a slider manufacturing device according to a modified embodiment of the invention;

FIG. 12 shows a view of a laser irradiator of a slider manufacturing device according to a modified embodiment of the invention;

FIG. 13 shows a view illustrating a slider manufacturing method according to a second embodiment of the invention;

FIG. 13A shows an enlarged view of portion A of FIG. 13;

FIG. 14 shows a view illustrating a slider manufacturing method according to a third embodiment of the invention;

FIG. 15A shows a step of a slider manufacturing method of prior art;

FIG. 15B shows a step of a slider manufacturing method of prior art;

FIG. 15C shows a step of a slider manufacturing method of prior art;

FIG. 15D schematically shows an enlarged view of a separated slider shown in FIG. 15C;

FIG. 15E shows a cross-sectional view along X-X line of FIG. 15D; and

FIG. 15F shows a cross-sectional view along Y-Y line of FIG. 15D.

### DETAILED DESCRIPTION OF THE INVENTION

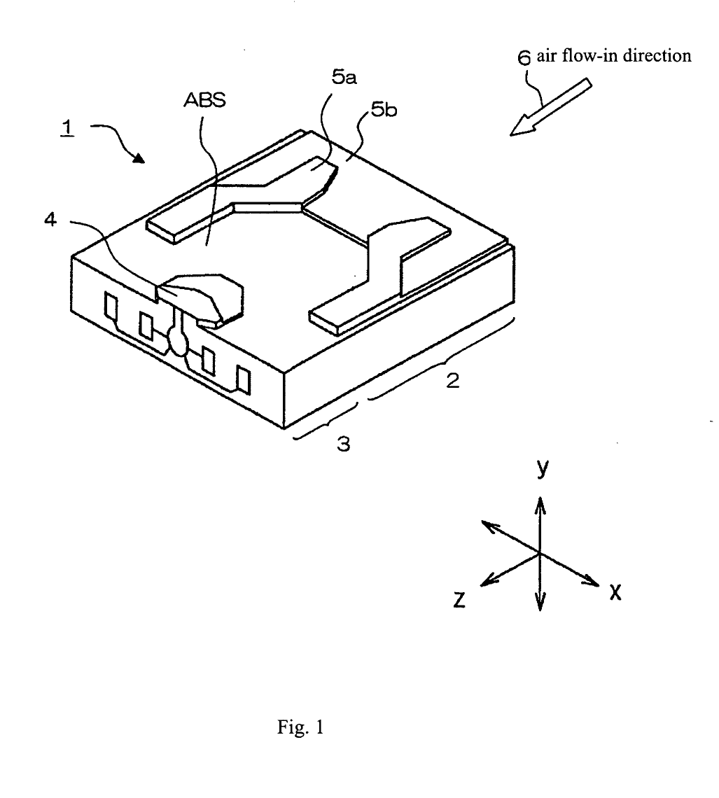

A slider manufacturing method and device of the invention will now be described in detail in conjunction with drawings. FIG. 1 shows a perspective view of a slider involved in a slider manufacturing method of the invention. The slider 1 comprises a substrate 2 made of ceramic material such as Al2O3/TiC and a thin film magnetic head portion 3 formed by a deposition body. A rotary, disk-shaped recording medium (not shown) is disposed above (sometimes under) the slider 1. The slider 1 is approximately of a hexahedron shape and an air bearing surface (ABS) opposite to the recording medium is formed on one of the six surfaces. A read/write portion 4, which incorporates a reading/writing element of the thin film magnetic head portion 3, is formed on the ABS. Rail portions 5a, 5b are also formed on the ABS. Magnetic film element having magneto-resistive effect such as AMR (anisotropic magneto-resistance) element, GMR (giant magneto-resistance) element, or TMR (tunnel magneto-resistance) element may be used as a reading element. Any magnetic inductive element, for example element using horizontal recording manner in which recording happens in recording medium surface direction, or element using perpendicular recording manner in which recording happens out of recording medium surface direction may be used as a writing element.

When the recording medium rotates, airflow gets into the slider 1 from one side of the slider 1 along air flowing in direction 6, and goes out along rotation direction Z of the recording medium from back end portion of the slider 1 on which the thin film magnetic head portion 3 is disposed. That is, the airflow enters a gap formed between the rail portion 5b and the recording medium, and is regulated by the rail portions 5a and 5b, and then enters a gap formed between the read/write portion 4 and the recording medium. A downward lift force is generated by the airflow along Y direction, and the slider 1 floats above the recording medium surface.

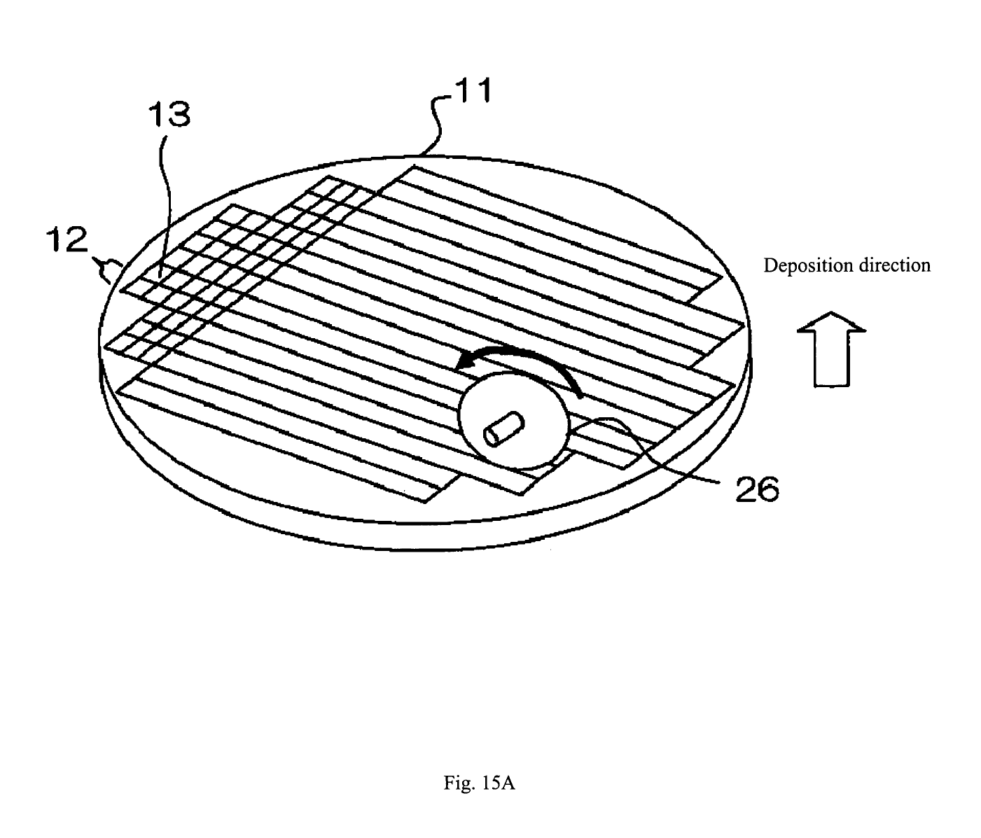

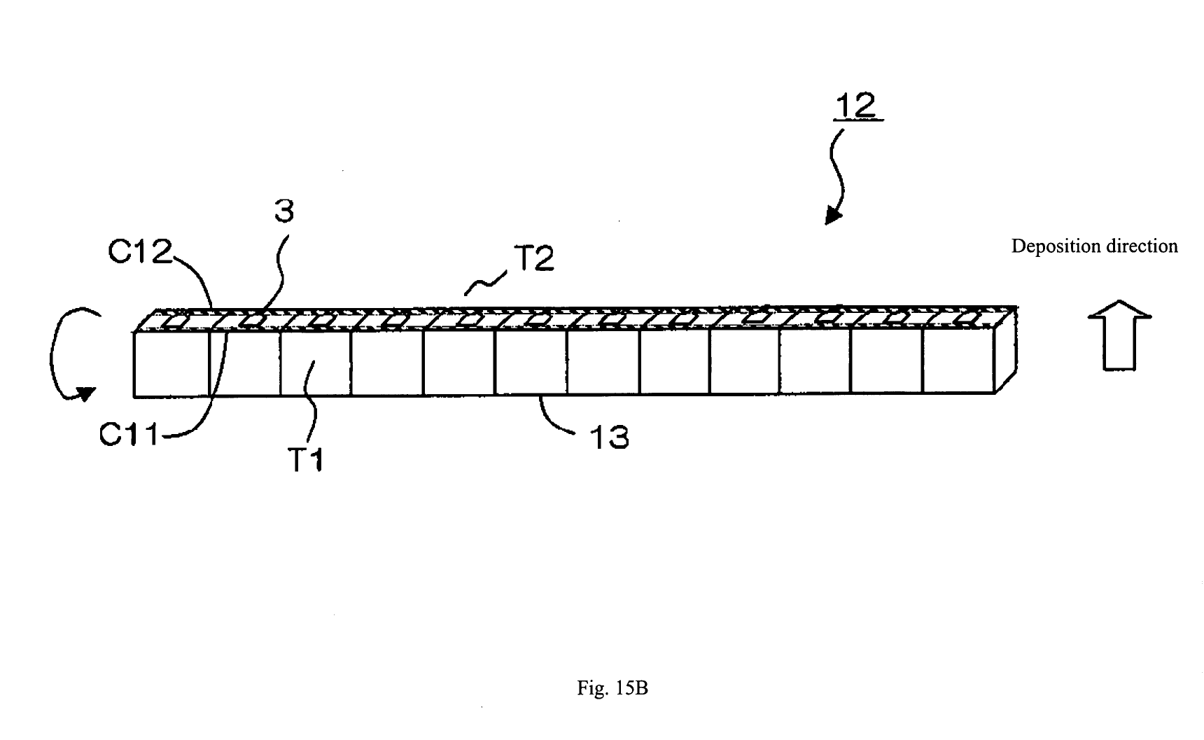

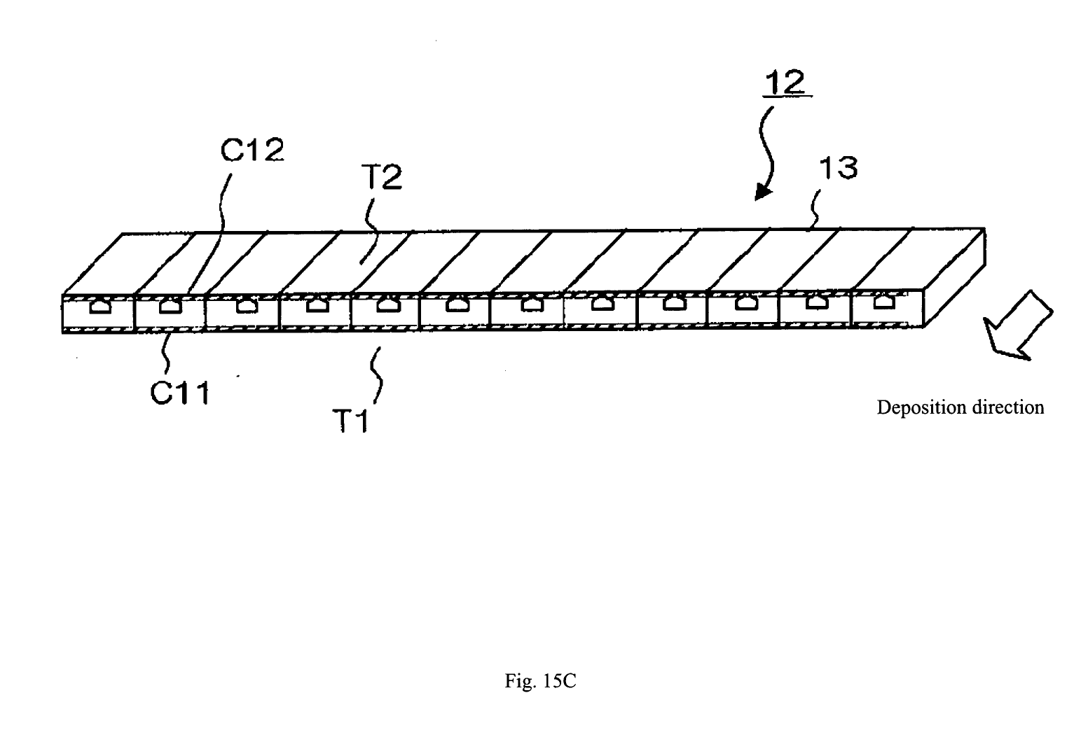

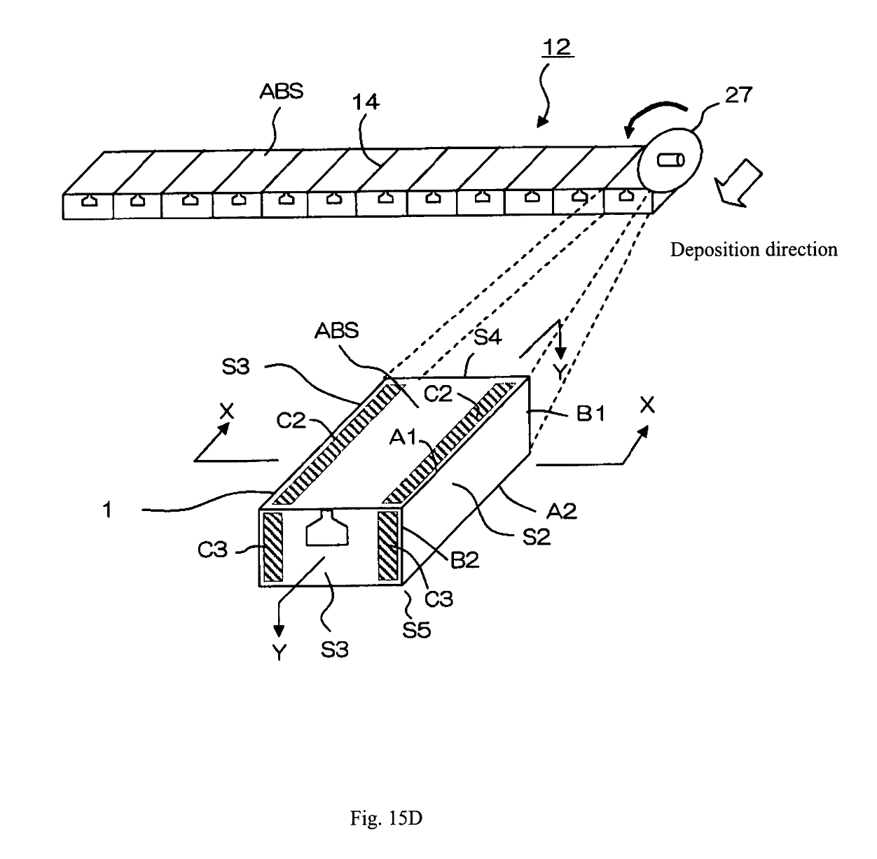

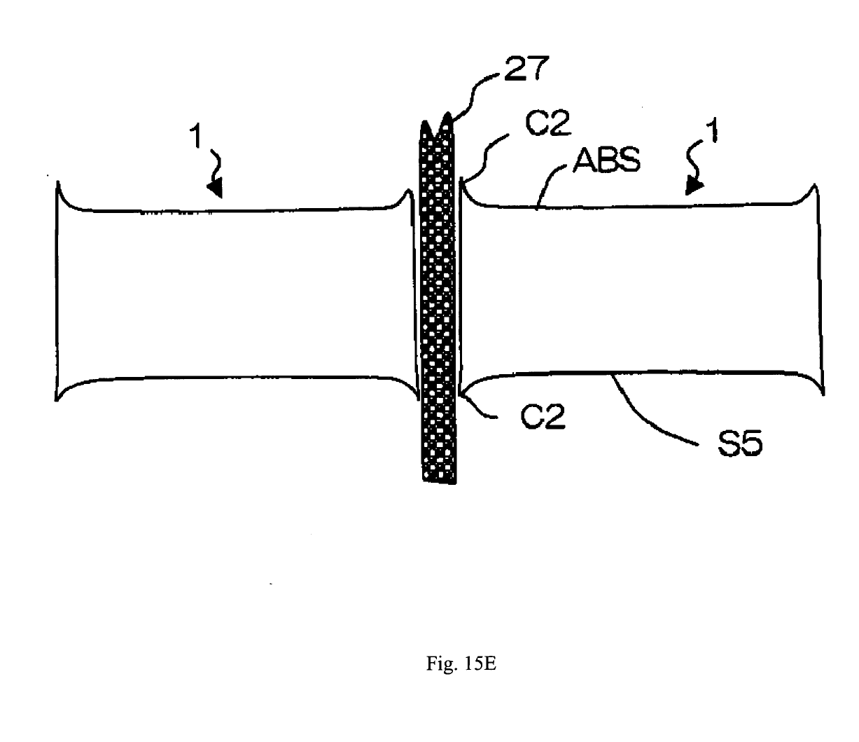

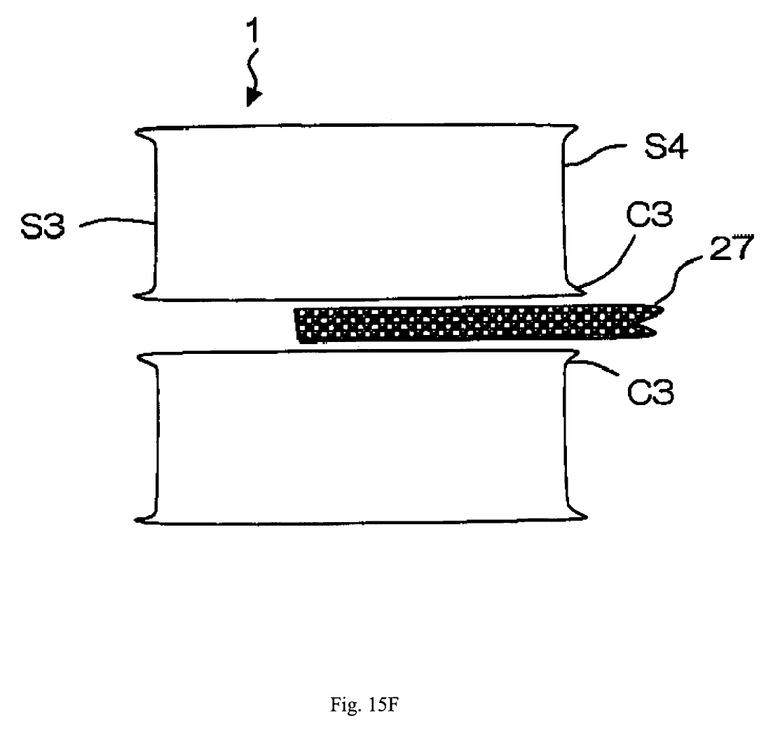

The rail portion 5a is the most extruded portion of the ABS with respect to the recording medium, while the read/write portion 4 is 1˜3 nm lower than that the rail portion 5a with respect to the recording medium. Height difference between the rail portions 5a and 5b is not necessary. A protection film (not shown) having a thickness of 1˜4 nm constructed by a compound film consisting of S1 and DLC (Diamond Like Carbon) is formed on the ABS. An inner surface S5 (refer to FIG. 15E) of the slider 1 opposite to the ABS is used to connect with the flexure (not shown) that supports the slider 1.

### First Embodiment

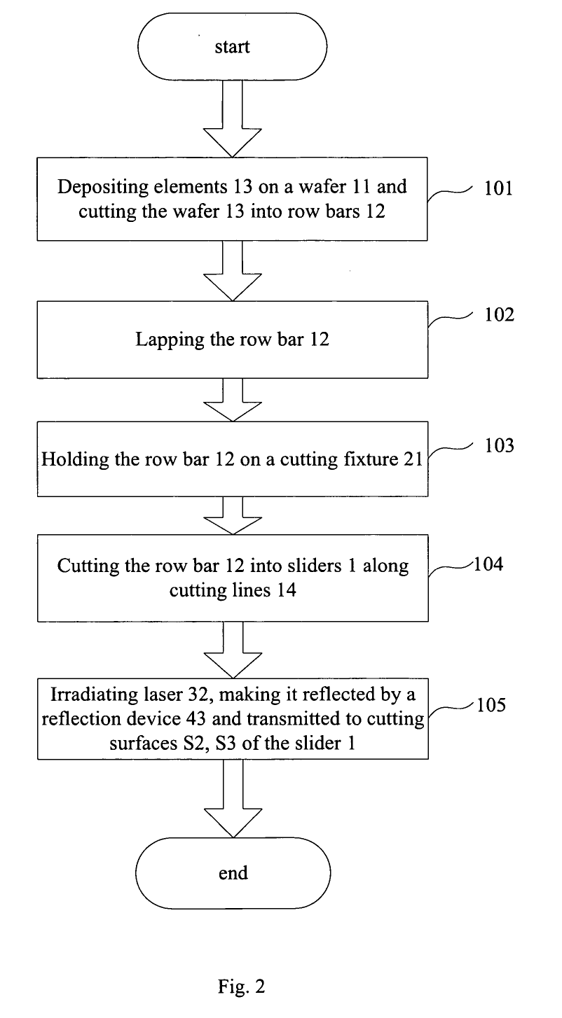

A first embodiment of slider manufacturing method of the invention will now be described in conjunction with the flowchart shown in FIG. 2.

(Step 101) Firstly, as shown in FIG. 15A, a plurality of elements 13 that serve as sliders 1 are deposited on a wafer 11 by a thin film process, and then as shown in FIG. 15B, the wafer 11 is cut to form a bar-shaped row bar 12, along length direction of which the plurality of elements 13 are arrayed. The row bar 12 is cut off along a cutting surface T2, on which a surface to be formed as the ABS is exposed. In addition, a test element (not shown) that engages with several elements 13 is preferably disposed on the wafer 11 in advance for controlling grinding volume of the ABS in step 102.

(Step 102) Next, the row bar 12 is lapped to form a defined MR height for a MR element and a throat height for a writing element. Furthermore, rail portions 5a, 5b are formed on the ABS by suitable means such as ion milling.

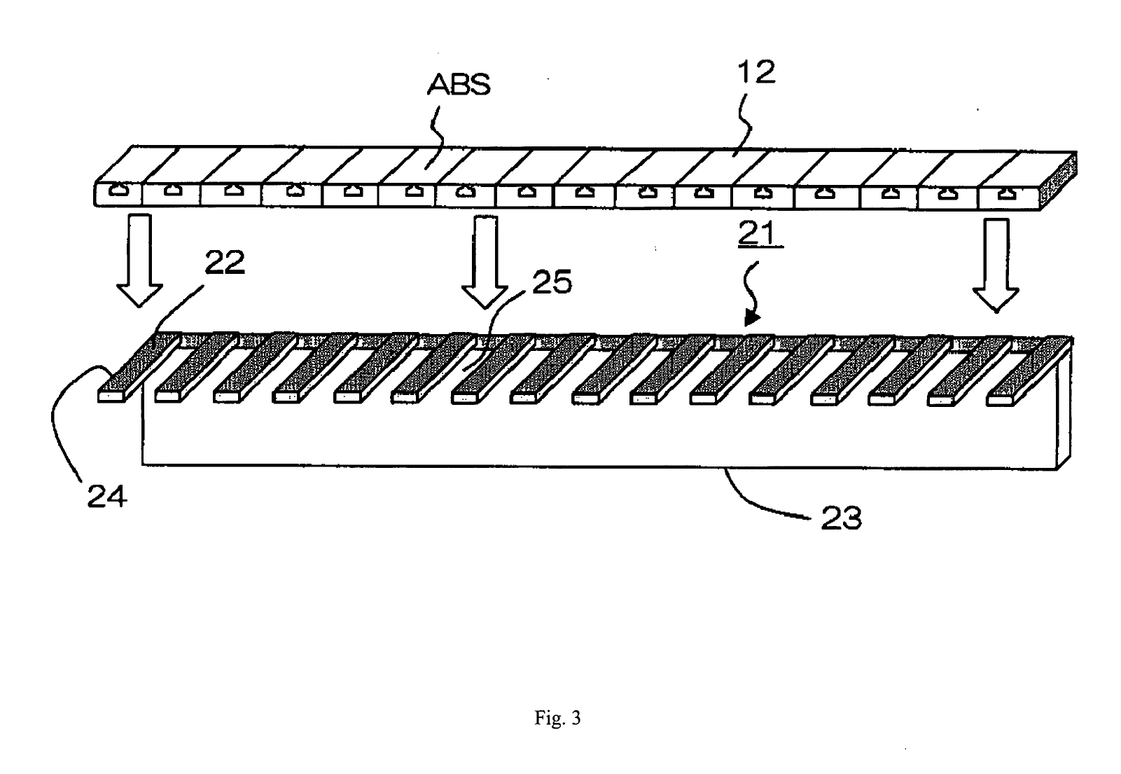

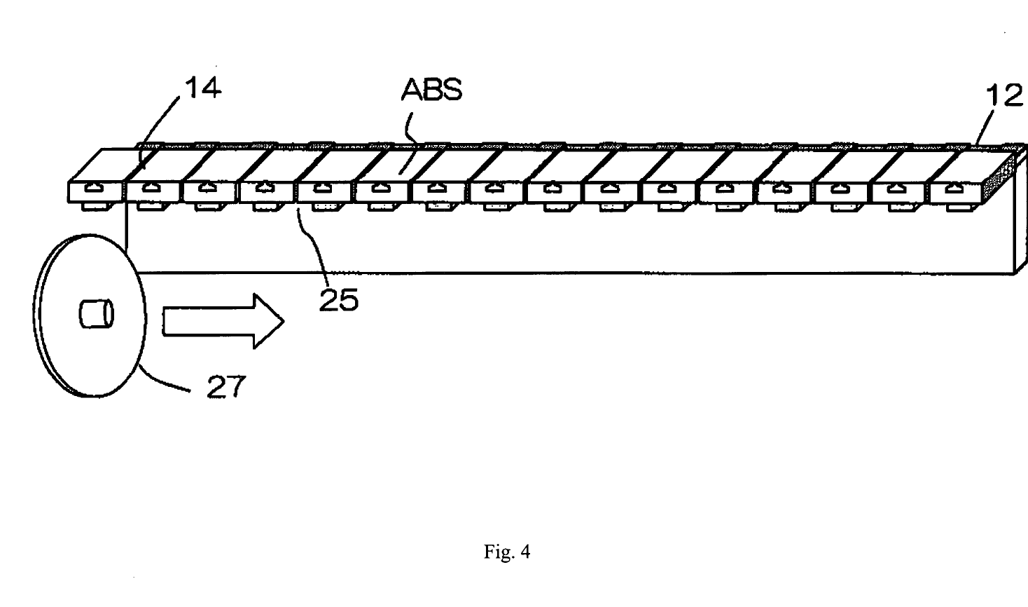

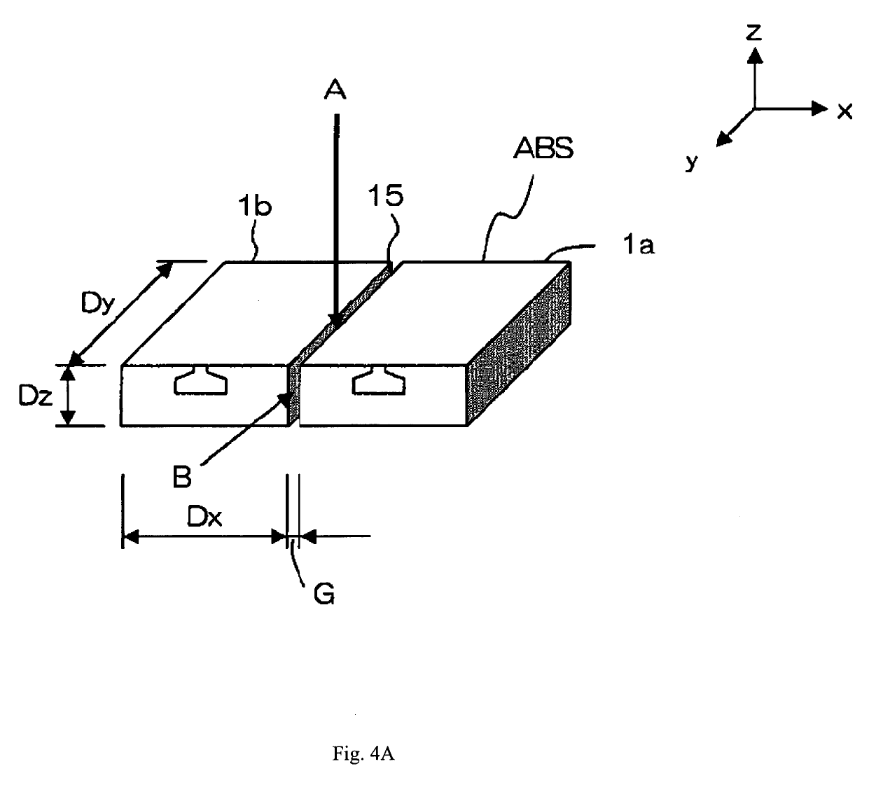

(Step 103) Then, the row bar 12 is placed on a cutting fixture 21. As shown in FIG. 3, the cutting fixture 21 comprises a support plate 23 and a plurality of slider support portions 22 carried thereon in form of an array, a gap 25 being formed between the slider support portions 22. As shown in FIGS. 3, 4, the row bar 12 is fixed to holding surfaces 24 of the slider support portions 22 by adhesive with cutting lines 14 of the row bar 12 aligned with the gaps 25 and the ABS facing up. The cutting fixture 21 also protects the sliders in later process of removing the burrs by laser.

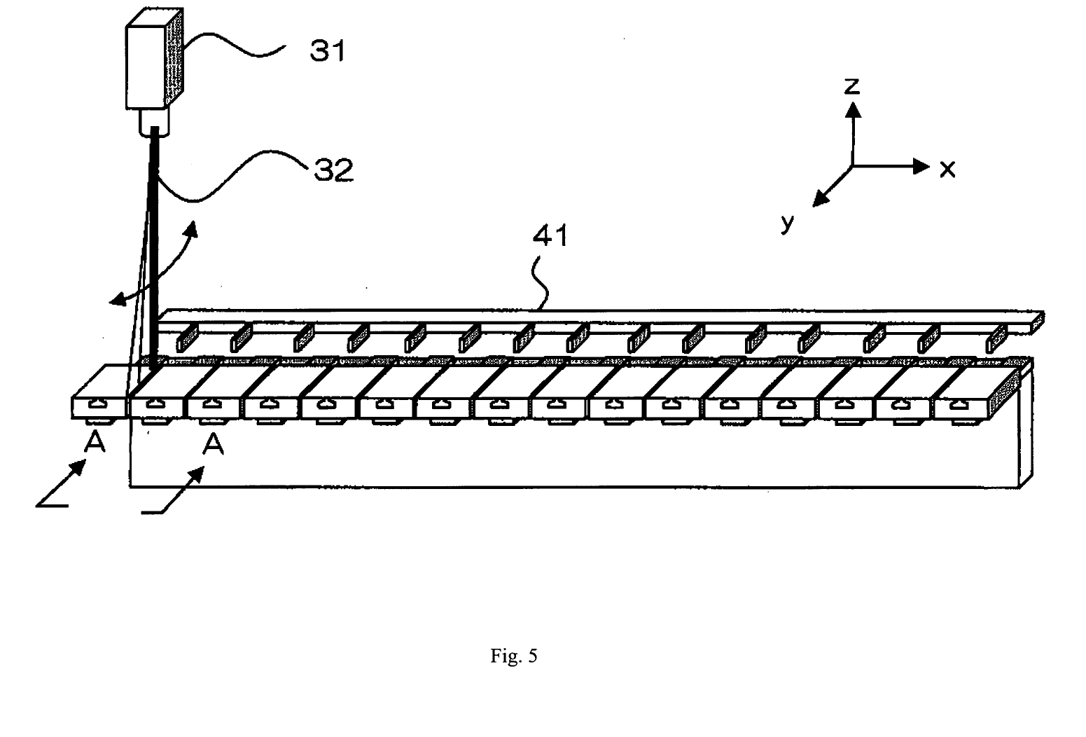

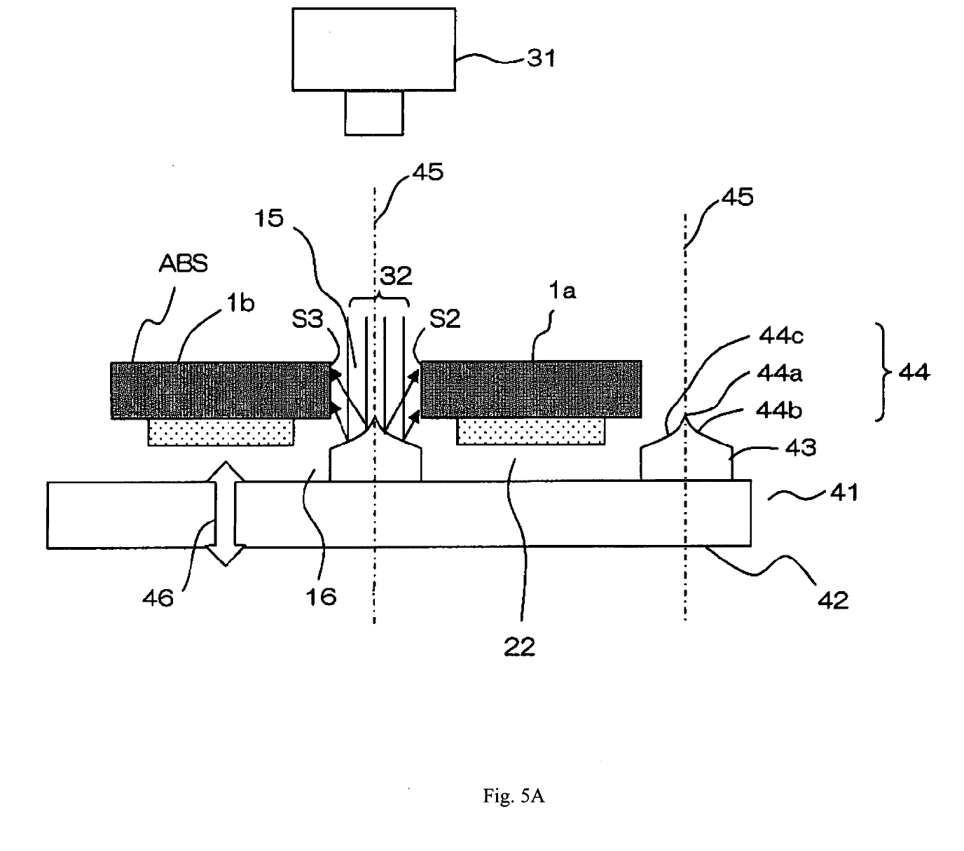

(Step 104) Next, as shown in FIG. 4, the row bar 12 is cut into sliders 1 along the cutting lines 14. A grinding stone 27 is used in the cutting process. Since the cutting lines 14 are aligned with the gaps 25 previously, when the grinding stone 27 runs into the gap 25, it keeps no touch with the cutting fixture 21. Therefore, the row bar 12 is cut off in a status of being supported by the cutting fixture 21. FIG. 4A shows a partial perspective view of the divided row bar 12. As illustrated, the separated sliders 1 are held toward each other with a space 15 formed between cutting surfaces S2, S3 (refer to FIG. 5A) of adjacent sliders 1, the space 15 being corresponding with the cutting line 14 and generated due to cutting action.

Taken as an example, dimensions related to the slider 1 may be as follows: length Dx of the row bar 12 in longitudinal direction is about 1.0 mm, length Dy of the row bar 12 in depth direction is about 1.23 mm, and length Dz of the row bar 12 in thickness direction is about 0.3 mm. The dimensions may vary according to type of the sliders, but ratios between the dimensions have little difference. In addition, taken as an example, the cutting width, namely the width G of the space 15 in X direction is approximately 0.15 mm.

The grinding stone 27 is made of diamond and rotates at a speed of 5000˜20000 rpm. The grinding stone 27 moves along vector direction shown in FIG. 3 and cuts off all sliders 1 gradually. The sliders may also be cut off one by one, and steps 104, 105 may be repeated upon number of the sliders; or several sliders may be processed simultaneously. At this time, as shown in FIGS. 15D, 15E burrs C2 are formed on the cutting surfaces.

In addition, though one of the cutting surfaces S2, S3 may not be a cutting surface which is on a slider 1 located inside the wafer 11 and generated in the step 104, in this situation it is a cutting surface, along which the wafer 11 is cut into row bars 12 in the step 101. Therefore, the burrs C2 remain on cutting surfaces S2, S3 of the all sliders 1.

(Step 105) As shown in FIG. 5, a laser irradiator 31 is disposed above the cutting fixture 21 (ABS), and a reflection fixture 41 is disposed below the cutting fixture 21. FIG. 5A shows a cross-sectional view of FIG. 5 along A-A line. In the figure, the cutting fixture 21 is omitted for more clarity. The reflection fixture 41 has many reflection devices 43 carried on a support plate 42, and the reflection device 43 is positioned in a space 16 behind the space 15 when viewed from the laser irradiator 31. When the reflection fixture 41 is placed at one side of the sliders 1, each reflection device 43 will be inserted into respective space 15. Here quantity of the reflection devices 43 is consistent with that of the cutting lines 14 (i.e., quantity of the spaces 15), thus enabling them to be inserted into all the spaces 15; moreover, one or more reflection devices 43 may also be inserted into respective spaces 15 in order. The reflection device 43 is capable of moving along a direction perpendicular to the longitudinal direction of the cutting fixture 21. However, absolute perpendicularity is unnecessary; movement along component direction of the irradiating direction 46 of the irradiation device is acceptable.

The reflection device 43 includes a reflection surface 44 facing the laser irradiator 31. The reflection surface 44 has a convex structure with its center 44a protruded toward the laser irradiator 31. In the embodiment shown in the figure, the centerline of the center 44a approximately coincides with that of the space 15, and reflection surfaces 44b, 44c are symmetrically and smoothly extended from both sides of the centerline 45 in a direction away from the laser irradiator 31. That is, the reflection surface 44 has at least two reflection angles relative to the laser irradiator 31.

When the laser irradiator 31 transmits laser 32 toward the space 15, the laser 32 gets to the reflection surface 44 of the reflection device 43, part of the laser 32 is reflected by the reflection surface 44b and transmitted to the cutting surface S2 of a slider la adjacent the space 15. The remained laser 32 is reflected by the reflection surface 44c and transmitted to the cutting surface S3 of another slider 1b adjacent the space 15. Meanwhile, the entire laser 32 may also be transmitted to any one of the cutting surfaces S2, S3. As described above, the laser 32 is irradiated from the laser irradiator 31, reflected by the reflection device 43, and transmitted to both cutting surfaces S2 and S3 in a direction different from the irradiation direction 46.

Additionally, in the embodiment, reflection surfaces 44b, 44c are slightly concave with respect to the laser irradiator 31 respectively. Accordingly, the reflected laser more convergent than the laser beam 32 is irradiated to the cutting surfaces S2 and S3. However, as irradiating condition, the reflection surface may also be formed as a convex surface so as to enlarge irradiation range, or be a complex reflection surface.

Preferably, wavelength of the laser falls in 200˜3000 nm. The laser in this range of wavelength can be easily absorbed by surface of the slider 1 and transformed to heat around the surface of the slider 1 more efficiently. Furthermore, it is preferable that radiant intensity of the laser fall in 0.2˜4.0 mJ/mm². If the radiant intensity is lower than 0.2 mJ/mm², Al2O3/TiC that forms the substrate 2 or aluminum that is main material to form the thin film magnetic head portion 3, will not reach their melting point temperature; therefore sufficient effect will not be achieved. If higher than 4.0 mJ/mm², big thermal deformation will be generated on the slider 1. Based on the radiation energy, radiation time is preferably 0.01˜0.1 seconds, and most desirably is 0.02 seconds. In addition, the irradiated beam is not limited to laser, and generally speaking, electromagnetic wave that irradiates desired energy may also get the same effect.

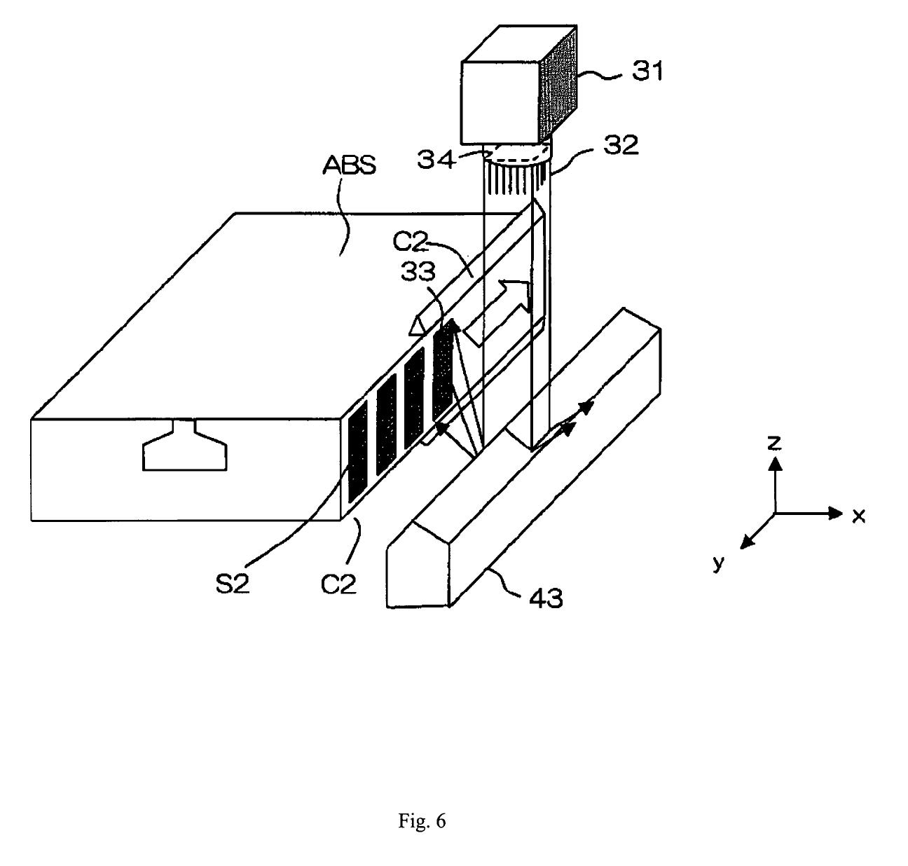

FIG. 6 illustrates irradiation situation of the cutting surface S2. As shown in FIG. 5, the laser irradiator 31 sways (or slides) along Y direction (direction designated by a hollow arrow in the figure). By this means, the laser irradiator 31 sweeps along Y direction.

Vicinity 33 is the middle portion of the cutting surface S2, and the burrs C2 themselves or edges of the cutting surface S2 (edges A1, A2, B1 and B2 shown in FIG. 15D) are out of the irradiation range. That is, the burrs C2 are removed by irradiating and heating the cutting surface S2 using laser, thus changing balance of residual stress generated in cutting process, but not removed by physical method.

As for irradiation method, it is preferable to move a rectangular irradiation region along Y direction gradually, the rectangular irradiation region being long in Z direction and short in X direction. In this irradiation method, compressive stress is applied in Z direction (direction along longer side), while almost no compressive stress is applied in Y direction; hence the burrs can be removed effectively. A shield portion 34 is disposed on the irradiation portion of the laser irradiator 31, and the shield portion 34 changes the shape of irradiated laser to a rectangular shape. The shield portion 34 may be designed to have a shape from which a single rectangular beam is irradiated each time; however, it may also be designed to have a shape from which several rectangular beams are irradiated each time. When the latter shape is utilized, the work efficiency can be improved, because several irradiation regions are irradiated at the same time. The laser beam may be of a circle shape, and in this case, the diameter thereof is preferably 30 μm or larger. If the diameter is smaller than the value, the melted area will be narrower and positions radiated be spotted. Consequently, effect of eliminating burrs substantially will not be achieved, and production efficiency will be degraded extremely. Moreover, the laser, which is not converged, may also be irradiated to the entire cutting surface S2.

As shown in FIG. 15, the incidence angle θ along which the laser is irradiated to the cutting surface S2 is preferably 15 degrees or bigger. If the angle is smaller than 15 degrees, the laser radiated to the cutting surface S2 will be reflected strongly, thus decreasing radiation efficiency.

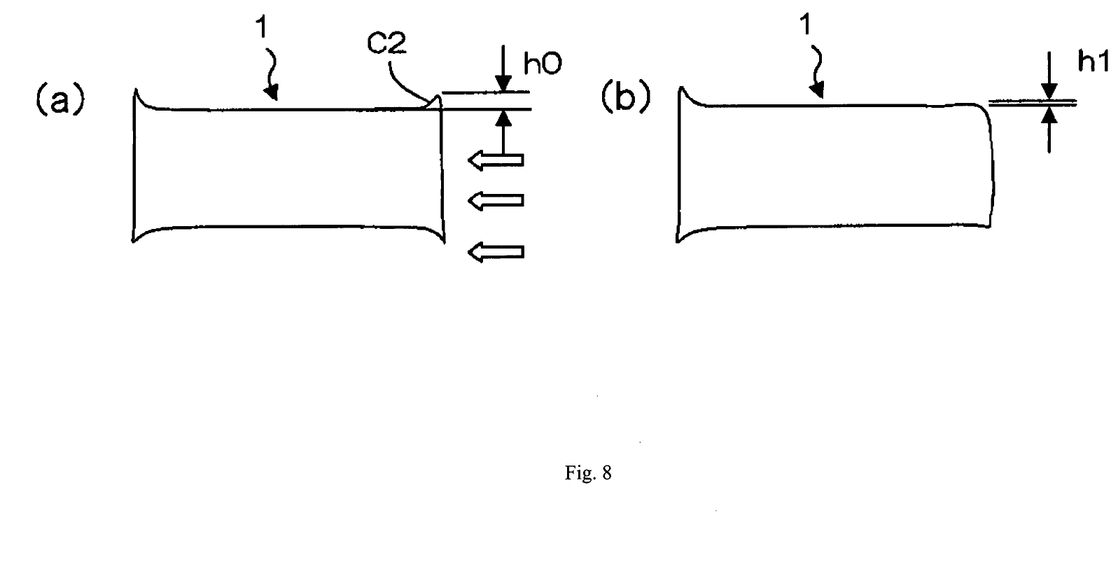

By irradiation of the laser, Al2O3/TiC is melted by heat of the laser or recoagulated, thus making shrinkage of the heated portion. With the shrinkage, compressive stress is generated underneath the surface being irradiated (the cutting surface). As a result, compressive stress is produced on irradiated portions of the cutting surface S2, and burrs C2 as shown in FIG. 8(a) is eliminated effectively as that shown in FIG. 8(b). As a purpose of the invention to prevent stretching of the burrs towards the ABS, the height of the burrs generated around the cutting surface can be reduced from h0 to h1 (in some cases the height may also be zero or below completely).

The invention is not limited to above embodiments, and may have various modified embodiments. First of all, the convex configuration of the reflection surface of the reflection device may be replaced by a concave configuration.

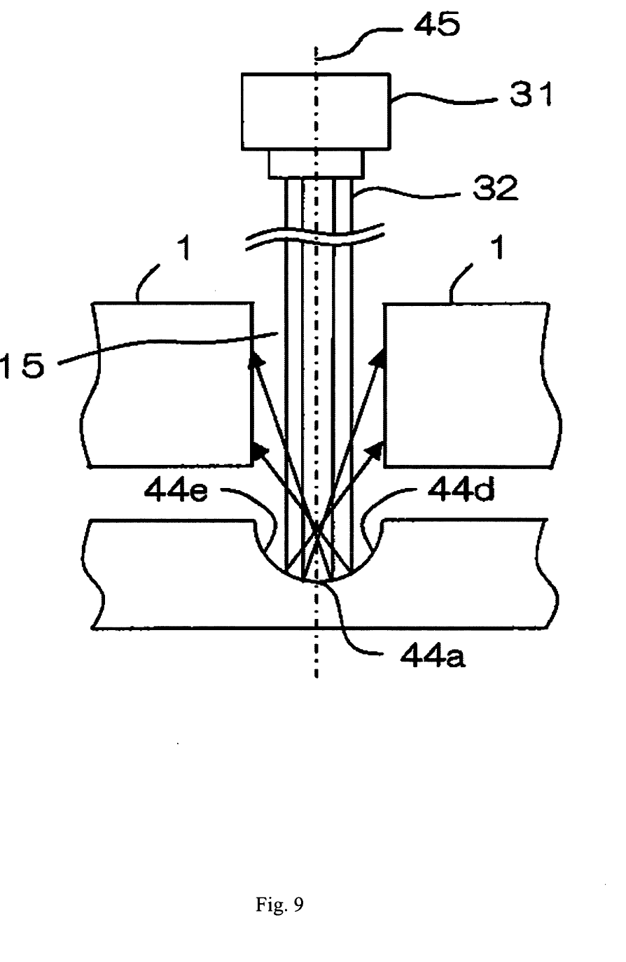

As shown in FIG. 9, reflection surfaces 44d, 44e are smoothly extended from both sides of the centerline 45 in a direction approaching the laser irradiator 31; concretely, the reflection surfaces 44d, 44e are extended from the center 44a toward the laser irradiator 31. The reflected rays of laser radiate in a crossover manner and realize the same effect as the above embodiment.

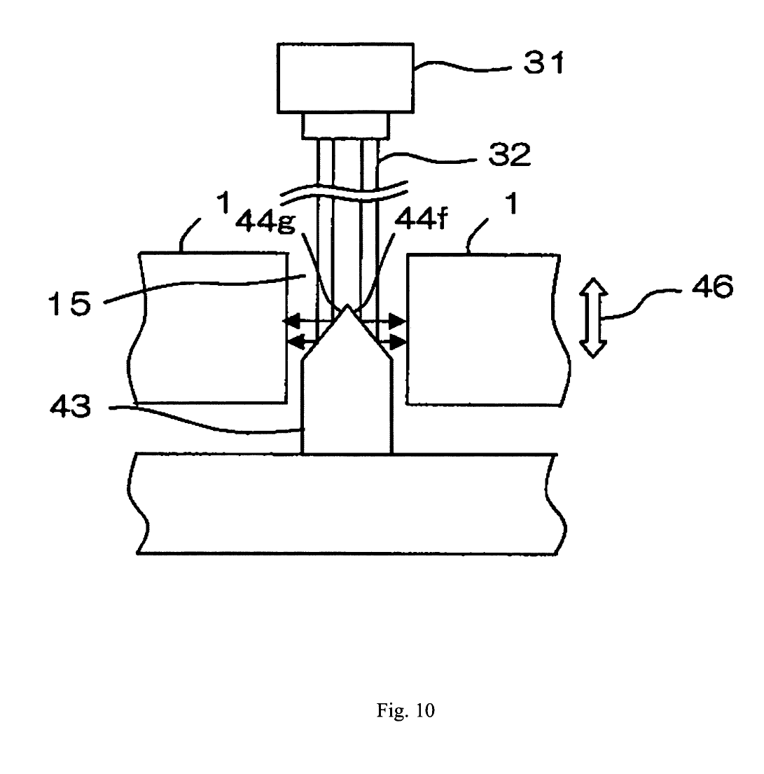

Moreover, as shown in FIG. 10, the reflection device 43 locates in the space 15 and the reflection surface may have a convex shape constructed by reflection surfaces 44f and 44g of straight line. In this embodiment, compared with the reflection device disposed in the backspace, since the reflection device 43 is closer to the cutting surface, accordingly, the reflected laser can be converged easily and the irradiation range thereof is confined. Moreover, when the reflection device 43 is moved slowly in the space 15 along the irradiation direction 46, the reflection device 43 scans the cutting surface in the irradiation direction 46, thus easily realizing the scan process. Specifically, in the process, the laser radiates toward longitudinal edge of the slider (direction of vector A of FIG. 4a), other than toward transverse edge thereof (for example, ABS (direction of vector B of FIG. 4a)). Therefore, irradiation can be effectively and evenly performed at the longitudinal direction.

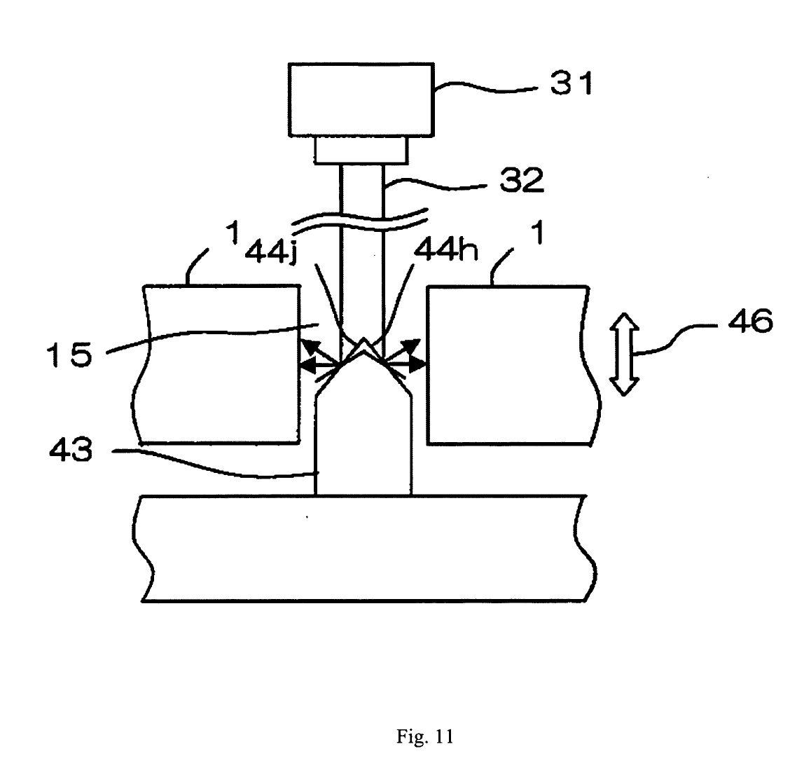

Furthermore, as shown in FIG. 11, the reflection device 43 is positioned in the space, and reflection surfaces 44h, 44j may be designed to be rotatable via a galvanometer mirror. In the embodiment, since the spaces 15, i.e., locations of the sliders 1 of the cutting fixture 21 are different from each other, an adjusting portion, which is disposed along the irradiation direction (angle of the irradiated laser) and will be described next has the function of compensating the incidence angle. Furthermore, the cutting surface is scanned along the irradiation direction 46 by rotating the reflection surfaces 44h, 44j gradually in the space 15, hence achieving the simple scan process abovementioned.

The location of the reflection device or shape of the reflection surfaces may have various modifications.

In addition, the location of the laser irradiator 31, i.e., the irradiation direction may be reversed. For example, when turns the drawing of FIG. 10 upside down, the laser irradiator 31 will have a structure of irradiating laser from other direction of the cutting fixture 21, and the same effect as the embodiment shown in FIG. 10 can be achieved. This configuration is useful when location of the laser irradiator 31 is limited due to environment restriction.

As illustrated above, when implementing a single irradiation step, in which laser rays are directed to a space and reflected to adjacent two cutting surfaces in the space, it is necessary to repeat the irradiation step for completely removing burrs remained on all the sliders 1.

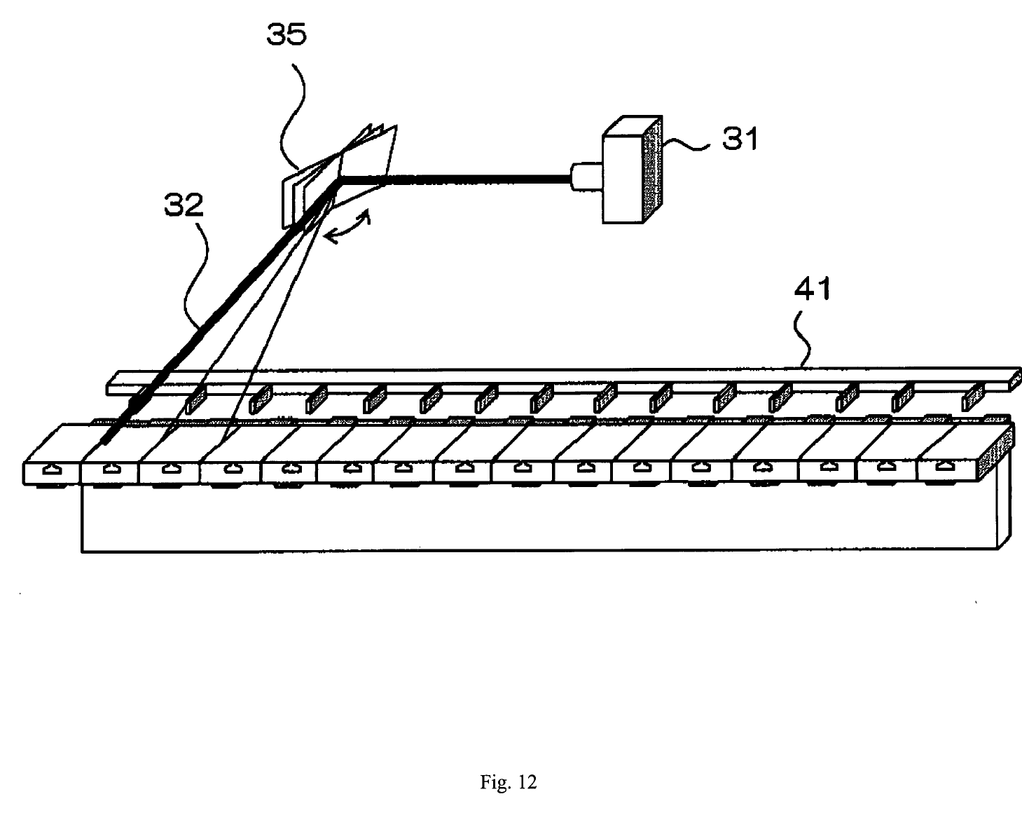

Correspondingly, as for the reflection fixture 41, there are two configuring methods. In one method as illustrated above, at least one reflection device 43 is provided and inserted into respective spaces orderly; in the other method, a number of reflection devices 43 are provided each of which can be inserted into respective space 15 simultaneously. As for configuration of the laser irradiator 31, one configuration is providing a transverse moving device in respective space to transversely move the laser irradiator 31 or the surface being irradiated; and another configuration involves in securing the laser irradiator 31 on its location and changing irradiation direction (irradiation angle) of the laser. FIG. 12 shows an embodiment in which a galvanometer mirror is utilized as the adjusting portion to adjust the abovementioned irradiation direction. Here, since the laser 32 is capable of radiating to any location within the space 15 by merely controlling angle of the galvanometer mirror 35, accordingly, complex structure such as the transverse moving device is unnecessary. Hence, compared with the transverse movement of the first method, the manner in which the angle of the galvanometer mirror 35 is controlled, can adjust irradiation position in a time not more than 1/100 of that of the first method, thus, making production efficiency higher than that of the first method. Moreover, the first and second method may be used in conjunction, when the laser cannot irradiate to all the sliders of the row bar 12 only by adjusting the angle of the galvanometer mirror 35.

### Second Embodiment

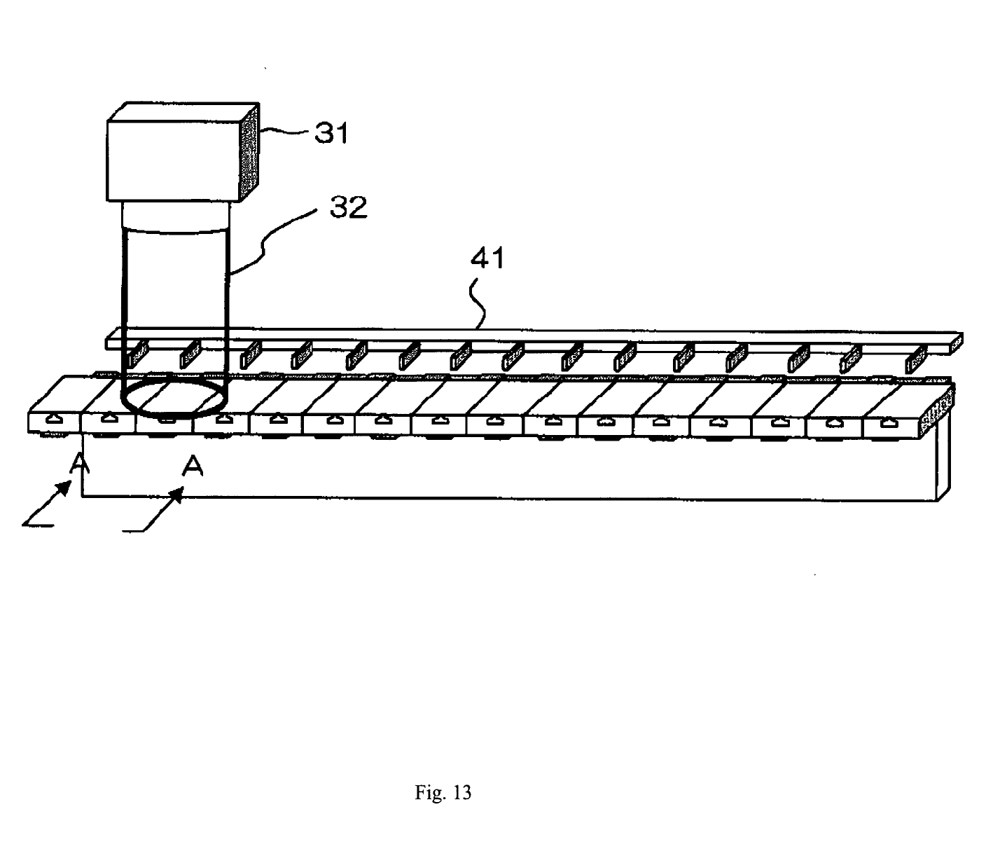

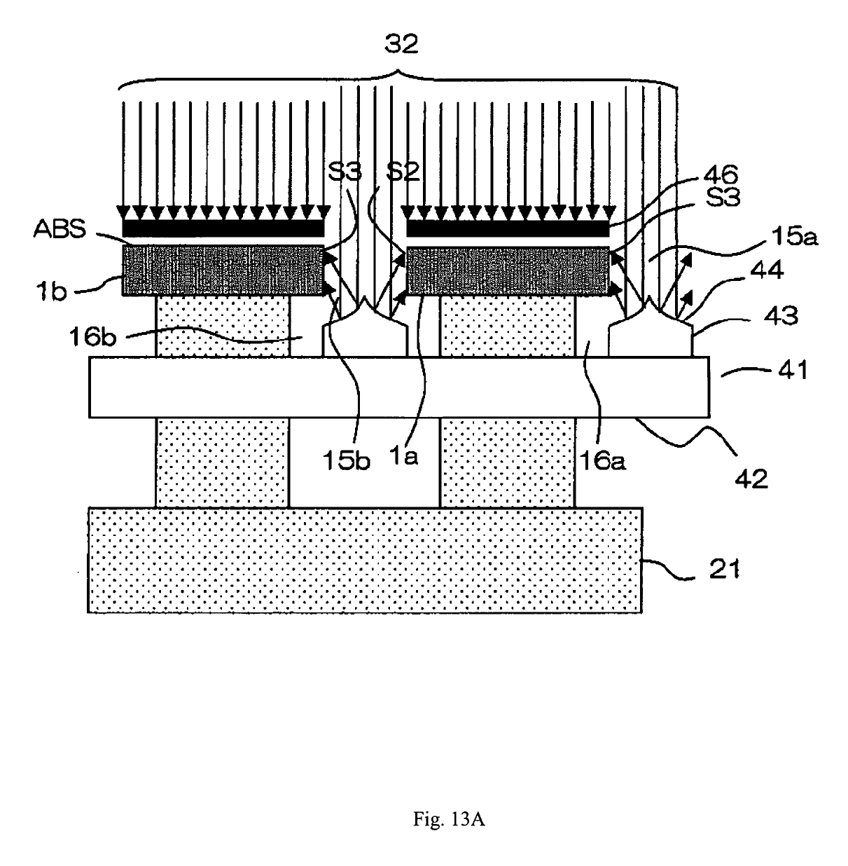

In this embodiment, the laser irradiator 31 transmits laser having a diameter of beam, which covers two or more spaces and a slider disposed between the spaces. Namely, in the embodiment all the irradiation steps can be implemented at the same time. FIG. 13 shows entire structure of the embodiment, and FIG. 13A shows a cross-sectional view of FIG. 13 along A-A line. As illustrated in figures, a laser irradiator 31 is provided above the cutting fixture 21, and a reflection fixture 41 is provided in a space 16 behind the space 15 when viewed from the laser irradiator 31. These structures are basically same with the first embodiment, and the difference is the laser irradiator 31 can transmit laser of larger beam diameter. Furthermore, at least two reflection devices 43 are disposed on the reflection fixture 41 for irradiating at least two spaces 15 at a time. Accordingly, a shield portion 46 is placed above the ABS, which faces the irradiation direction of the slider 1 for shielding the ABS from the irradiated laser 32.

The laser 32 can be directed to a slider 1a and spaces 15a, 15b formed at two sides of the slider 1a simultaneously. After passing through the respective spaces 15a, 15b, the irradiated laser 32 is reflected by a reflection device 43 located in spaces 16a, 16b behind the spaces 15a, 15b. The reflected laser 32 is transmitted to two adjacent cutting surfaces S2, S3 in respective back spaces 16a, 16b, and burrs are removed by a manner like that shown in the first embodiment.

In the embodiment, since laser irradiation may run at the same time, thereby time for manufacturing a single slider is reduced, thus improving production efficiency. Moreover, neither transverse moving device nor galvanometer mirror is needed to provide on the laser irradiator, thus reducing production cost.

### Third Embodiment

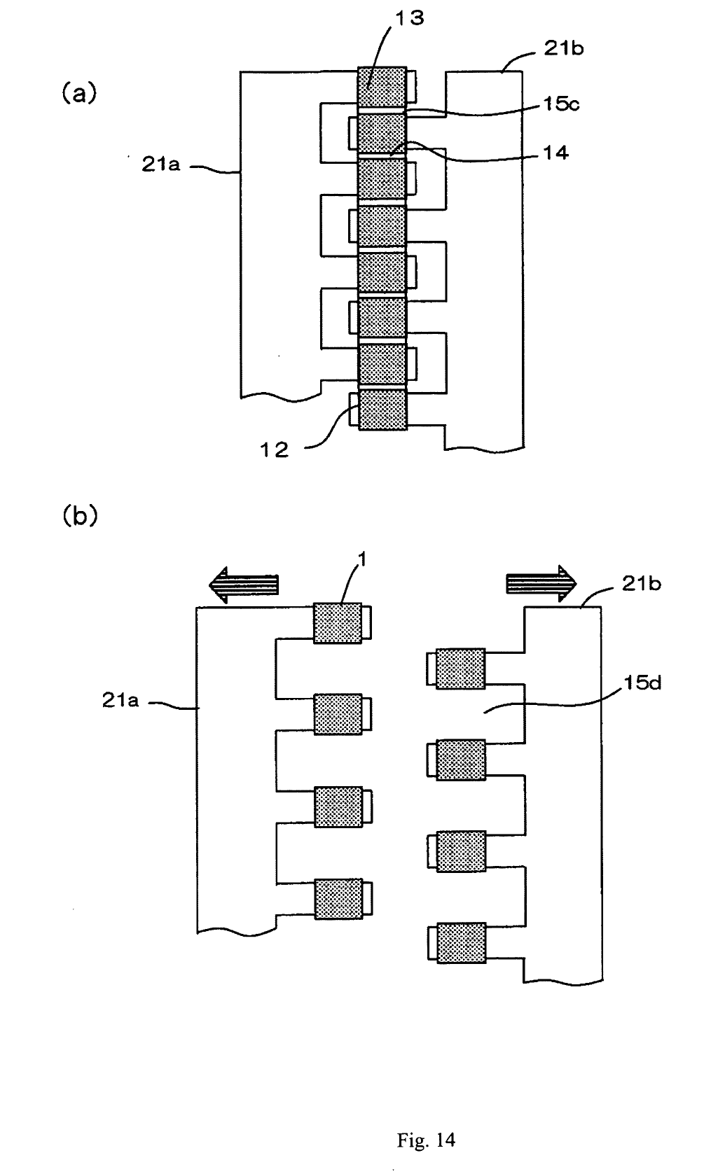

The embodiment provides a step, in which partial sliders are separated from a longitudinal axis of the row bar such that nonadjacent sliders become adjacent to each other and are held towards each other with a space formed between the cutting surfaces thereof. Firstly, as shown in FIG. 14(a), elements 13 used to form sliders 1 are held on cutting fixtures 21a, 21b which can be separated from each other, then the elements 13 are cut into sliders 1 along cutting lines 14. In this situation, the space 15c is very narrower; however, as shown in FIG. 14(b), a wider space 15d is obtained by separating the cutting fixtures 21a and 21b from each other. Consequently, method illustrated in the first and second embodiment can be applied in subsequent process. In future with minimization of the slider, the space between the sliders becomes narrower and narrower; as a result, it is difficult to place the reflection device in the space or a space behind the space, so the method is greatly useful in this situation.

Finally advantages of the invention are summarized. As described above, the invention uses electromagnetic wave irradiation such as laser irradiation to eliminate burrs generated on sliders after the row bar is cut into individual sliders. According to the invention, since burrs themselves can be removed, accordingly, it is unnecessary to consider existence of the burrs in slider design; hence limitation to further reduction in flying height of the slider is eliminated. In addition, more sliders may be readily formed on a wafer, as no pre-groove that widens the cutting width is formed to eliminate burrs. Thus, it is unnecessary to design the slider under consideration of residual burrs; therefore, design freedom of other portions of the ABS for example rail shape is increased.

The invention has an advantage of improving production efficiency. Concretely, in the invention, after the row bar is divided into individual sliders, the reflection device under condition that the cutting fixture is secured directly irradiates the laser. Consequently, compared to conventional method in which burrs are removed by grinding, the method of the invention is easier. Also, it is easy to add a laser radiation process to slider separating process, thus improving production efficiency. Moreover, by adjusting location or shape of the reflection surface, incidence angle, incidence range and irradiation energy of laser irradiated to the cutting surface can be controlled, thus removing the burrs more suitably. Also, the laser irradiator is available easily; therefore device increase is also small.

What is claimed is:

1. A manufacturing method of slider, comprising the steps of:
cutting step; at which cutting a row bar constituted by an array of slider-forming elements into individual sliders; and
radiating step; at which radiating electromagnetic wave and making it reflected and transmitted to a cutting surface of the individual slider in a direction different from a direction of radiating the electromagnetic wave, so as to reduce a height extending from an air bearing surface of the individual slider of burrs, which are generated around the cutting surface of individual slider.

2. The manufacturing method according to claim 1, wherein in the cutting step, the separated sliders are held face to face, and a cutting space is formed between the cutting surfaces of the two adjacent sliders, which has a size comparative to a cutting line for cutting the row bar.

3. The manufacturing method according to claim 1, wherein in the cutting step, a part of the sliders are moved to deviate from a longitudinal axis of the row bar so as to make the nonadjacent sliders being adjacent to each other and are held face to face with a space formed between the cutting surfaces thereof.

4. The manufacturing method according to claim 3, wherein in the radiating step, a part of the irradiated electromagnetic wave is reflected at a direction different from a direction of the rest electromagnetic wave, and the part of the electromagnetic wave has at least a part to radiate to a side of the facing cutting surfaces of the adjacent sliders, and the rest electromagnetic wave has at least a part to radiate to the other side of the facing cutting surfaces of the adjacent sliders.

5. The manufacturing method according to claim 4, wherein the radiating step comprises an individual radiating step of irradiating the electromagnetic wave to one of the spaces, then making the irradiated electromagnetic wave reflected to the cutting surfaces at two sides adjacent the space after the electromagnetic wave passes through the space or during passing process.

6. The manufacturing method according to claim 5, wherein the radiating step comprises:
individual radiating step, at which irradiating a space between a first slider and a second slider which adjacent to each other; and
another individual radiating step, at which altering irradiation direction of the electromagnetic wave and irradiating a space between the second slider and a third slider which adjacent to each other.

7. The manufacturing method according to claim 4, wherein the radiating step comprises an entire radiating step of irradiating the electromagnetic wave to at least one slider and spaces at two sides of the slider, and making the irradiated electromagnetic wave reflected to the cutting surfaces at two sides adjacent the space after the electromagnetic wave passes though or during passing process.

8. The manufacturing method according to claim 7, wherein in the entire radiating step, the electromagnetic wave is irradiated under condition that the slider is shielded from irradiation of the electromagnetic wave.

9. The manufacturing method according to claim 1, wherein in the cutting step, the row bar is held on a cutting fixture in advance, and then cut into the individual sliders in a status of being held on the cutting fixture; in the radiating step, the electromagnetic wave is radiated directly to the cutting surfaces of the sliders when they are held on the cutting fixture.

10. The manufacturing method according to claim 1, wherein in the radiating step, the electromagnetic wave is irradiated in a direction with an incline angle of 15 degrees or larger relative to the cutting surface.

11. The manufacturing method according to claim 1, wherein the electromagnetic wave is a kind of laser having a wavelength of 200˜3000 nm.

12. The manufacturing method according to claim 11, wherein the laser has an irradiation intensity of 0.2˜4.0 J/mm².

13. A device for manufacturing slider, comprising:
a fixture, which holding a plurality of sliders adjacent to each other, wherein a cutting space is formed between the cutting surfaces of the two adjacent sliders formed by cutting the row bar, which has a size comparative to a cutting line for cutting the row bar;
an electromagnetic wave irradiator; and
a reflection device, which reflecting the electromagnetic wave irradiated by the irradiator and transmits the reflected electromagnetic wave onto the cutting surfaces of the sliders at a direction different from an irradiation direction of the irradiator.

14. The device according to claim 13, wherein at least a part of the reflection device is provided in the cutting space or a rear space behind the cutting space when viewed from the irradiator; and the reflection device comprises at least two reflection angles relative to the irradiation direction of the irradiator, and a reflection surface to radiate the electromagnetic wave to the cutting surfaces at two sides of the cutting space or the rear space corresponding to the reflection angle.

15. The device according to claim 14, wherein the reflection device is movable along a direction which has the irradiation direction of the irradiator as a vector element.

16. The device according to claim 14, wherein the reflection surface has a convex configuration with its center extruding toward the irradiator.

17. The device according to claim 14, wherein the reflection surface has a concave configuration with its center recessed away from the irradiator.

18. The device according to claim 14, wherein the irradiator has an adjusting portion to adjust the irradiation direction of the irradiator.

19. The device according to claim 14, further comprising at least two reflection devices concomitantly provided in the different cutting spaces or rear spaces.

20. The device according to claim 19, wherein the irradiator irradiates electromagnetic wave having a beam diameter that covers the different cutting spaces and the sliders sandwiched between the cutting spaces.

21. The device according to claim 20, further comprising a shield portion to shield the sliders sandwiched between the cutting spaces from irradiation of the electromagnetic wave.

22. The device according to claim 13, wherein the irradiator irradiates laser.

23. The device according to claim 13, wherein the fixture also acts as a row bar cutting fixture.
